(19) United States
(12) Patent Application Publication
(10) Pub. No.: US 2020/0099326 A1
(43) Pub. Date: Mar. 26, 2020

(54) REGULATING DEVICE FOR AN ELECTRIC MACHINE, ELECTRIC DRIVE SYSTEM, AND METHOD FOR REGULATING AN ELECTRIC MACHINE

(71) Applicant: Robert Bosch GmbH, Stuttgart (DE)

(72) Inventors: Florian Malchow, Stuttgart (DE); Maximilian Manderla, Ludwigsburg (DE)

(21) Appl. No.: 16/490,935

(22) PCT Filed: Feb. 14, 2018
(86) PCT No.: PCT/EP2018/053683

§ 371 Date: Dec. 6, 2019

(30) Foreign Application Priority Data
Mar. 7, 2017 (DE) 10 2017 203 691.5

(51) Int. Cl. H02P 23/04

(52) U.S. Cl. CPC H02P 23/04; H02P 2207/05; H02P 2207/01

(57) ABSTRACT

The invention relates to the regulation of an electric machine, wherein an interference variable is compensated for and simultaneously a target value is set. In the process, two mutually independent control loops are provided. A first control loop is used to compensate for the interference variable, and a second control loop is used to set a specified target value. When the specified target value is being regulated, the control loop is decoupled from the interference variable compensation process. In this manner, a modular independent regulation can be achieved for the target value and the interference variable compensation process.

### BACKGROUND OF THE INVENTION

The present invention relates to a regulating device for an electric machine, an electric drive system with such a regulating device and a method for regulating an electric machine. In particular, the present invention relates to the regulation of an electric machine for minimizing an interference variable.

Publication DE 10 2009 000 930 A1 discloses a method and an arrangement for reducing the torque ripple in a permanent magnet motor system. The motor system comprises a permanent magnet motor, which is coupled to an inverter. The method described in this publication comprises a step for modifying operating control signals, in order to generate ripple-reducing operating control signals. These modified operating control signals are delivered to an inverter for controlling the permanent magnet motor.

On account of their design, induction machines, such as for example cage rotor asynchronous machines or permanent magnet synchronous machines, do not have an ideal sinusoidal flux distribution in the air gap. During operation, this leads to irregular torques containing harmonics during regulation with sinusoidal currents. In order to minimize harmonic waves, two basic approaches are possible. One approach consists in a targeted controlled connection of a superimposed exogeneous compensation voltage to the motor voltage. Alternative approaches are based on an additional control loop. In this case, a target torque can for example first be specified in an inner control loop, said target torque then being superimposed from the exterior by a compensation method for higher harmonic oscillations.

### SUMMARY OF THE INVENTION

The present invention discloses a regulating device for an electric machine, an electric drive system and a method for regulating an electric machine.

Accordingly:

A regulating device is provided for an electric machine with a first regulating unit, a second regulating unit, a computing device and a control device. The first regulating unit is designed to provide a first target variable to minimize an interference variable at an operating point of the electric machine. The computing device is designed to calculate a change in the operating point of the electric machine based on driving the electric machine with a first target variable. The second regulating unit is designed to provide a second target variable for setting a specified target value for the electric machine. In particular, a target value can be set for the operating point. The second target variable for the second regulating unit is determined using a difference between a detected value of the operating point and the change in the operating point calculated in the computing device when driving with the first target variable provided by the first regulating unit. In other words, the second regulating unit determines the second target variable on the basis of a calculated operating point, which would result without influencing by the first target variable. The control device is designed to drive the electric machine using a combination of the first target variable and the second target variable.

Furthermore:

An electric drive system is provided with an electric machine and a regulating device according to the invention.

Furthermore:

A method is provided for regulating an electric machine with the steps of determining a first target variable to minimize an interference variable at an operating point of the electric machine and of calculating a change in the operating point of the electric machine on the basis of driving the electric machine with the determined first target variable. The method further comprises a step for calculating a difference between a value of the operating point determined by measurement and the calculated change in the operating point based on driving with the first target variable. Furthermore, the method comprises a step for determining a second target variable for setting a specified first target value in the electric machine using the difference between the detected value of the operating point and the calculated change in the operating point based on driving by means of the first target variable. Finally, the method comprises a step for driving the electric machine using a combination of the determined first target variable and the determined second target variable.

The present invention is based on the knowledge that when a regulation takes place, such as is used for example to drive an electric machine, and wherein on the one hand a specified target variable is to be set and on the other hand an interference variable is also to be compensated for, these two inputs mutually influence one another.

The present invention is thus based on the idea of taking this knowledge into account and providing a regulation for an electric machine, wherein the setting of the specified target value and the compensation of an interference variable can be decoupled from one another and thus designed in a modular manner and independently of one another. For this purpose, provision is made to use in each case two control loops decoupled from one another for the compensation of the interference variable and the setting of a target value for an operating variable. A first control loop is provided for the compensation of the interference variable. A second control loop is provided exclusively for setting a specified target value. In this control loop, the determined actual value of the operating variable is not used as an input variable, but rather a value of the operating variable at which the influence of the interference variable compensation has been separated out. For this purpose, it is necessary to determine the influence of a target variable for the interference variable compensation, and to separate this influence out in the control loop for setting the target value of the actual operating variable.

As a result of such decoupling of the interference variable compensation and the regulation of the target value, it is possible to achieve a particularly precise and efficient regulation for an electric machine. An existing regulation system without interference compensation can be incorporated unchanged.

Such an improved regulation of the electric machine with interference variable compensation thus enables the use of modern, cost-effectively optimized electric machines, which without interference variable compensation could only provide diminished running properties. With the regulating device according to the invention, the running properties of the electric machines can thus be improved. In particular, the price for an electric drive system can also be reduced by the use of modern cost-effective electric machines.

According to an embodiment, the operating point of the electric machine comprises a torque, a magnetic flux of the electric machine and/or an electric current of the electric machine. In particular, the operating point can comprise for example the phase current or the phase currents in the electrical phases of the machine. The operating point of the electric machine can be both a directly detectable or detected operating point, or alternatively also an operating point which is calculated beforehand, possibly indirectly, from other variables of the electric machine. Thus, conclusions can also be drawn about the torque in the electric machine, for example from known electric currents in the machine, without the torque having to be detected directly by means of a sensor. In the case of a regulating device which for example uses the torque of an electric machine as an operating point, the torque ripple can thus be reduced. This enables particularly smooth running of the machine.

According to an embodiment, the interference variable at the operating point comprises a ripple or a harmonic oscillation, for example in a torque. Ripples or harmonic oscillations are a widespread phenomenon in electric drive systems. The smooth running of the electric machine can be increased by minimizing such interference variables.

According to an embodiment, the first target variable and/or the second target variable, which are provided by the first regulating unit and respectively the second regulating unit, comprise an electric voltage, which is to be set on the electric machine. In particular, the first target variable and/or the second target variable can also comprise electric voltages for a field-orientated regulation of an electric machine.

According to an embodiment, the control device is designed to provide an electric voltage on the electric machine. For example, the control device can comprises a rectifier, which adjusts the appropriate phase voltages on the basis of the combination of the first and second target variable of an electric machine.

According to an embodiment, the computing device is designed to set the first target variable using a specified second target value. By specifying a second target value for the interference variable compensation in the first regulating unit, the interference variable compensation can be suitably set by different operating modes or, where appropriate, other operating points or operating states.

According to an embodiment, the regulating device comprises a sensor, which is designed to detect the operating point of the electric machine and to provide a variable corresponding to the operating point of the electric machine. The operating point to be detected can either be directly detected or, if appropriate, other parameters of the electric machine can also be detected and the operating point of the electric machine can then be calculated from the latter.

According to an embodiment of the electric drive system, the electric machine comprises an asynchronous machine or a permanently excited synchronous machine.

The above embodiments and developments can, insofar as advisable, be combined arbitrarily with one another. Further embodiments, developments and implementations of the invention also include not explicitly mentioned combinations of features of the invention described above or in the following in respect of the examples of embodiment. In particular, the person skilled in the art will also add individual aspects as improvements or supplements to the respective basic forms of the present invention.

### BRIEF DESCRIPTION OF THE DRAWINGS

The present invention is explained in greater detail below with the aid of the examples of embodiment given in the schematic figures of the drawing.

In the figures:

FIG. 1: shows a schematic representation of an electric drive system with a regulating device for an electric machine according to an embodiment; and

FIG. 2: shows a schematic representation of a flow chart, such as it underlies a method for regulating an electric machine according to an embodiment.

### DETAILED DESCRIPTION

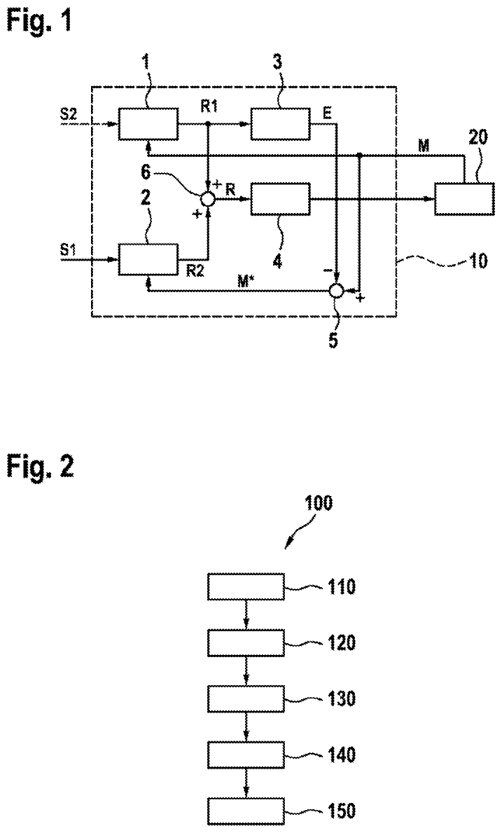

FIG. 1 shows a schematic representation of an electric drive system with a regulating device for an electric machine 20. The electric drive system comprises a regulating device 10 in electric machine 20. Regulating device 10 comprises a first regulating unit 1, a second regulating unit 2, a computing device 3 and a control device 4. A first target variable R1, to which an operating point of electric machine 20 is to be set, can for example be specified on second regulating unit 2. This first target value 51 can for example be a torque, which is to be set in electric machine 20. Moreover, any other operating point, such as for example an electric current to electric machine 20, and also any other operating points are however also possible. Second regulating unit 2 then determines, from specified target value 51 and a current value of the operating point, a target variable R2 for driving electric machine 20. In contrast with a conventional regulation, it is not the actual current value of the operating point of electric machine 20 that is used in second regulating unit 2, but rather a modified value of the operating point described in greater detail below.

First regulating unit 1 evaluates the current value at an operating point M, for example the torque or the electric current to electric machine 20. First regulating unit 1 can in particular detect an interference variable at detected operating point M. This interference variable can for example be a ripple at operating point M, and in particular a ripple with a harmonic oscillation corresponding to the rotary frequency of electric machine 20. Moreover, any other interference components in operating variable M are however also possible in principle. First regulating unit 1 then generates a first target variable R1. This first target variable R1 corresponds to a target variable for compensating for the detected interference component at operating point M. First target variable R1 is thus used to minimize or, as the case may be, to completely compensate for the component of the interference variable at operating point M. First target variable R1 for compensating for the interference variable is combined with second target variable R2 for setting a specified target value S1 and this combination of the two target variables R1 and R2 is fed to control device 4. For example, the combination of first target variable R1 and second target variable R2 can take place in summing element 6. Summing element 6 then outputs target variable R from the combination of first target variable R1 and second target variable R2. The combination of first target variable R1 and second target variable R2 is then fed to control device 4. This control device 4 then drives electric machine 20 according to the combination of the two target variables R1 and R2. Control device 4 can for example be an electrical rectifier which, corresponding to target variable R, sets corresponding electric voltages at the phase connections of electric machine 20. Moreover, any other drive of electric machine 20 based on the combination of first target variable R1 and second target variable R2 is however also possible. Whereas first regulating unit 1 directly evaluates operating point M for the compensation of the interference variable at operating point M, second regulating unit 2 carries out a regulation which is decoupled from the interference variable compensation by first regulating unit 1. For this purpose, second regulating unit 2 is provided with a modified operating variable M*, which corresponds to the operating variable of electric machine 20 without interference variable compensation. For this purpose, the component of the interference variable compensation at operating variable M has to be removed from operating variable M, before operating variable M* thus modified can be provided for second regulating unit 2.

In order to determine the component of the interference variable compensation in operating variable M, first target variable R1 of first regulating unit 1 is fed to a computing device 3. Computing device 3 calculates a component of operating variable M that corresponds to first target variable R1. The calculation can take place for example by modelling the electric drive system. For the calculation, any models, in particular any simulation models, can be used which enable the component of the interference variable compensation in operating variable M to be calculated from first target variable R1. Computing device 3 thus delivers a theoretical operating variable E as an output value, which would result when driving solely with first target variable R1. This theoretical component E according to first target variable R1 is subtracted from actual operating variable M. Input variable M* of second regulating unit 2 thus results from the difference between actual operating variable M and component E of the operating variable according to first target variable R1. This difference can be generated for example in a subtraction element 5.

By removing component E corresponding to first target variable R1 in operating variable M, the regulation in second regulating unit 2 thus takes place decoupled from the interference variable compensation in first regulating unit 1. First regulating unit 1 and second regulating unit 2 thus form two regulating units decoupled from one another, which do not influence one another or only do so minimally. A modular structure of the regulation for an interference variable compensation and the setting of a target value, for example for a torque or suchlike, can thus take place. This enables a particularly simple, efficient and precise approach to regulating an electric drive system. In particular, the interference variable compensation and the control loop for setting the operating variable, for example of the torque or suchlike, can take place independently of one another. Moreover, the decoupling and modularisation of the two target variables also enables the reuse of existing blocks or modules in other drive systems, without the latter having to be completely redeveloped for this purpose.

First regulating unit 1 can carry out an interference variable compensation on the basis of fixed specified parameters. In particular, a maximum compensation of the interference variable component in operating variable M can for example be specified. Moreover, any other boundary conditions that can be specified fixed in first regulating unit 1 are also possible. Moreover, it is however also possible to adapt the interference variable compensation dynamically in first regulating unit 1. Depending on an operating mode of the electric drive system, different compensation stages can for example be specified for the interference variable compensation. Thus, for example, a maximum interference variable compensation can be specified in a first operating mode and only a limited or, if appropriate, no interference variable compensation can be specified in a further operating mode. The running properties of the electric drive system are changed by the restriction or complete elimination of the interference variable compensation. This can be used for example to display a possible dangerous situation to a user.

Moreover, it is also possible to specify a further target value S2, to which the regulation of the first regulating unit is to be set. In this way, it is also possible to incorporate, as appropriate, one or more further parameters, boundary conditions or environmental properties into the regulation of first regulating unit 1.

Electric machine 20 can be any electric machine, such as for example an asynchronous machine or a permanently excited synchronous machine. The drive by control device 4 can be adapted according to electric machine 20 used. Different operating points M can also be regulated by regulating device 10 according to the given machine.

FIG. 2 shows a schematic representation of a flow chart, such as it underlies a method 100 for regulating an electric machine 20 according to an embodiment. A first target variable R1 is determined in step 110. This first target variable R1 is determined, as previously described, for the minimization of an interference variable at an operating point M of electric machine 20. In step 120, a value is then calculated, which corresponds to a change in first operating point M of electric machine 20 on account of driving electric machine 20 with determined first target variable R1. In step 130, a difference is calculated between a detected value of operating point M and calculated change E in operating point M based on driving with first target variable R1. In step 140, a second target variable R2 is calculated, which is used to set a specified target value S1 in electric machine 20. Finally, in step 150, electric machine 20 is calculated using a combination of determined first target variable R1 and determined second target variable R2.

To sum up, the present invention relates to a regulation for an electric machine, in which an interference variable is compensated for and a target value is set simultaneously. Two mutually independent control loops are thereby provided. A first control loop is used to compensate for the interference variable. A second control loop is used to set a specified target value. When the specified target value is being regulated, the control loop is decoupled from the interference variable compensation. In this way, a modular independent regulation can be achieved for the target value and the interference variable compensation.

1. A regulator (10) for an electric machine (20), the regulator (10) comprising:
a first regulating unit (1) configured to provide a first target variable (R1) to minimize an interference variable at an operating point (M) of the electric machine (20);
a computer (3) configured to calculate a change (E) in the operating point (M) of the electric machine (20) based on driving the electric machine (20) with the first target variable (R1);
a second regulator (2) configured to provide a second target variable (R2) for setting a specified target value (S1) in the electric machine (20), wherein the second target variable (R2) is determined using a difference between a detected value of the operating point (M) and the calculated change (E) in the operating point (M) based on driving with the first target variable (R1); and
a control device (4), configured to drive the electric machine (20) using a combination of the first target variable (R1) and the second target variable (R2).

2. The regulator (10) as claimed in claim 1, wherein the operating point (M) of the electric machine (20) comprises a torque of the electric machine (20).

3. The regulator (10) as claimed in claim 1, wherein the interference variable at the operating point (M) comprises a ripple at the operating point (M).

4. The regulator (10) according to claim 1, wherein the first target variable (R1) comprises an electric voltage which is to be set on the electric machine (20).

5. The regulator (10) according to claim 1, wherein the control device (4) is configured to provide an electric voltage on the electric machine (20) for phase connections of the electric machine (20).

6. The regulator (10) according to claim 1, wherein the computer (3) is configured to set the first target variable (R1) using a specified second target value (S2).

7. The regulator regulating device (10) according to claim 1, comprising a sensor which is configured to detect the operating point (M) of the electric machine (20) and to provide a variable corresponding to the operating point (M) of the electric machine (20).

8. An electric drive system, with:
an electric machine (20); and
a regulator (10) according to claim 1.

9. The electric drive system according to claim 8, wherein the electric machine (20) comprises an asynchronous machine.

10. A method (100) for regulating an electric machine (20), the method (100) comprising:
determining (110) a first target variable (R1) to minimize an interference variable at an operating point (M) of the electric machine (20);
calculating (120) a change (E) in the operating point (M) of an electric machine (20) on basis of driving the electric machine (20) with the determined first target variable (R1);
calculating (130) a difference between a detected value of the operating point (M) and the calculated change (E) in the operating point (M) based on driving with the first target variable (R1);
determining (140) a second target variable (R2) for setting a specified first target value (S1) in the electric machine (20); and
driving (150) the electric machine (20) using a combination of the determined first target variable (R1) and the determined second target variable (R2).

11. The electric drive system according to claim 8, wherein the electric machine (20) comprises a permanently excited synchronous machine.

12. The regulator (10) as claimed in claim 1, wherein the operating point (M) of the electric machine (20) comprises an electric current of the electric machine (20).

13. The regulator (10) as claimed in claim 1, wherein the interference variable at the operating point (M) comprises a harmonic oscillation at the operating point (M).

14. The regulator (10) according to claim 1, wherein the second target variable (R2) comprises an electric voltage which is to be set on the electric machine (20).
